(19) United States
(12) Patent Application Publication
(10) Pub. No.: US 2026/0121367 A1
(43) Pub. Date: Apr. 30, 2026

(54) LASER CHAMBER, DISCHARGE-EXCITATION-TYPE GAS LASER DEVICE, AND ELECTRONIC DEVICE MANUFACTURING METHOD

(71) Applicant: Gigaphoton Inc., Tochigi (JP)

(72) Inventors: Hitoshi OHGA, Oyama-shi (JP); Makoto TANAKA, Oyama-shi (JP); Youichi YAMANOUCHI, Oyama-shi (JP)

(73) Assignee: Gigaphoton Inc., Tochigi (JP)

(21) Appl. No.: 19/320,315

(22) Filed: Sep. 5, 2025

(30) Foreign Application Priority Data
Oct. 28, 2024 (JP) 2024-188844

(51) Int. Cl. H01S 3/036; H01S 3/038; H01S 3/041

(52) U.S. Cl. CPC H01S 3/036; H01S 3/038; H01S 3/041

(57) ABSTRACT

A laser chamber of a discharge-excitation-type gas laser device includes first and second discharge electrodes, a fan arranged in the laser chamber and causing a laser gas in the laser chamber to circulate, and a cooling unit arranged in the laser chamber and cooling the laser gas. Here, at least a part of a gas guide surface out of an inner surface of the laser chamber extends between first and second virtual curves over a first section corresponding to a phase angle of a magnitude of 90° or more of first and second virtual logarithmic spirals. The inner surface defines a flow path of the laser gas through which the laser gas flows between the first and second discharge electrodes to a vicinity of the cooling unit. The first and second virtual curves each have a curvature decreasing along the flow direction.

### CROSS-REFERENCE TO RELATED APPLICATIONS

The present application claims the benefit of Japanese Patent Application No. 2024-188844, filed on Oct. 28, 2024, the entire contents of which are hereby incorporated by reference.

### BACKGROUND

### 1. Technical Field

The present disclosure relates to a laser chamber, a discharge-excitation-type gas laser device, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 μm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be line-narrowed to the extent that the chromatic aberration can be ignored. For this purpose, there is a case in which a line narrowing module (LNM) including a line narrowing element (etalon, grating, and the like) is provided in a laser resonator of the gas laser device to line-narrow a spectral line width. A gas laser device with a narrowed spectral line width is referred to as a line narrowing gas laser device.

### LIST OF DOCUMENTS

### Patent Documents

Patent Document 1: Japanese Patent Application Publication No. 2003-298155
Patent Document 2: US Patent Application Publication No. 2021/199125
Patent Document 3: US Patent Application Publication No. 2023/151821

### SUMMARY

A laser chamber of a discharge-excitation-type gas laser device according to an aspect of the present disclosure includes first and second discharge electrodes arranged in the laser chamber as facing each other in a direction parallel to a first direction, each of the first and second discharge electrodes extending in a second direction perpendicular to the first direction; a fan arranged in the laser chamber, and configured to cause a laser gas in the laser chamber to circulate while rotating a flow direction of the laser gas about an axis parallel to the second direction; and a cooling unit arranged in the laser chamber, and configured to cool the laser gas. Here, when the laser chamber is viewed in cross-section in a plane perpendicular to the second direction, at least a part of a gas guide surface out of an inner surface of the laser chamber extends between first and second virtual curves over a first section corresponding to a phase angle of a magnitude of 90° or more of first and second virtual logarithmic spirals. The part of the gas guide surface is a part from a first position on an upstream side in the flow direction of the laser gas to a second position on a downstream side therein. The inner surface defines a flow path of the laser gas through which the laser gas flows between the first and second discharge electrodes to a vicinity of the cooling unit. The first virtual curve has a curvature decreasing along the flow direction and is a virtual curve from a first phase angle to a second phase angle of the first virtual logarithmic spiral having an angle of 103° at which a straight line from a first origin and a tangent line of the first virtual curve intersect each other. The second virtual curve has a curvature decreasing along the flow direction and is a virtual curve from the first phase angle to the second phase angle of the second virtual logarithmic spiral having an angle of 96° at which a straight line from the first origin and a tangent line of the second virtual curve intersect each other.

A discharge-excitation type gas laser device according to an aspect of the present disclosure includes an optical resonator, and a laser chamber arranged on an optical path of the optical resonator. Here, the laser chamber includes first and second discharge electrodes arranged in the laser chamber as facing each other in a direction parallel to a first direction, each of the first and second discharge electrodes extending in a second direction perpendicular to the first direction; a fan arranged in the laser chamber, and configured to cause a laser gas in the laser chamber to circulate while rotating a flow direction of the laser gas about an axis parallel to the second direction; and a cooling unit arranged in the laser chamber, and configured to cool the laser gas. When the laser chamber is viewed in cross-section in a plane perpendicular to the second direction, at least a part of a gas guide surface out of an inner surface of the laser chamber extends between first and second virtual curves over a first section corresponding to a phase angle of a magnitude of 90° or more of first and second virtual logarithmic spirals. The part of the gas guide surface is a part from a first position on an upstream side in the flow direction of the laser gas to a second position on a downstream side therein. The inner surface defines a flow path of the laser gas through which the laser gas flows between the first and second discharge electrodes to a vicinity of the cooling unit. The first virtual curve has a curvature decreasing along the flow direction and is virtual curve from a first phase angle to a second phase angle of the first virtual logarithmic spiral having an angle of 103° at which a straight line from a first origin and a tangent line of the first virtual curve intersect each other. The second virtual curve has a curvature decreasing along the flow direction and is a virtual curve from the first phase angle to the second phase angle of the second virtual logarithmic spiral having an angle of 96° at which a straight line from the first origin and a tangent line of the second virtual curve intersect each other.

An electronic device manufacturing method according to an aspect of the present disclosure includes generating laser light using a discharge-excitation-type gas laser device, outputting the laser light to an exposure apparatus, and exposing a photosensitive substrate to the laser light in the exposure apparatus to manufacture an electronic device. Here, the discharge-excitation-type gas laser device includes an optical resonator, and a laser chamber arranged on an optical path of the optical resonator. The laser chamber includes first and second discharge electrodes arranged in the laser chamber as facing each other in a direction parallel to a first direction, each of the first and second discharge electrodes extending in a second direction perpendicular to the first direction; a fan arranged in the laser chamber, and configured to cause a laser gas in the laser chamber to circulate while rotating a flow direction of the laser gas about an axis parallel to the second direction; and a cooling unit arranged in the laser chamber, and configured to cool the laser gas. When the laser chamber is viewed in cross-section in a plane perpendicular to the second direction, at least a part of a gas guide surface out of an inner surface of the laser chamber extends between first and second virtual curves over a first section corresponding to a phase angle of a magnitude of 90° or more of first and second virtual logarithmic spirals. The part of the gas guide surface is a part from a first position on an upstream side in the flow direction of the laser gas to a second position on a downstream side therein. The inner surface defines a flow path of the laser gas through which the laser gas flows between the first and second discharge electrodes to a vicinity of the cooling unit. The first virtual curve has a curvature decreasing along the flow direction and is a virtual curve from a first phase angle to a second phase angle of the first virtual logarithmic spiral having an angle of 103° at which a straight line from a first origin and a tangent line of the first virtual curve intersect each other. The second virtual curve has a curvature decreasing along the flow direction and is a virtual curve from the first phase angle to the second phase angle of the second virtual logarithmic spiral having an angle of 96° at which a straight line from the first origin and a tangent line of the second virtual curve intersect each other.

### BRIEF DESCRIPTION OF THE DRAWINGS

Embodiments of the present disclosure will be described below merely as examples with reference to the accompanying drawings.

FIG. 1 shows the configuration of a laser device of a comparative example.

FIG. 2 shows the configuration of a part of the laser device according to the comparative example viewed in a −Z direction.

FIG. 3 shows the flow of a laser gas in the comparative example.

FIG. 4 shows the definition of surface positions.

FIG. 5 shows the surface positions along the flow path of the laser gas in the comparative example.

FIG. 6 shows the configuration of a part of the laser device according to a first embodiment viewed in the −Z direction.

FIG. 7 shows first and second virtual curves.

FIG. 8 shows a first example of the shape of a gas guide surface extending between the first and second virtual curves.

FIG. 9 shows the surface positions along the flow path of the laser gas in the first embodiment.

FIG. 10 shows a second example of the shape of the gas guide surface extending between the first and second virtual curves.

FIG. 11 shows a third example of the shape of the gas guide surface extending between the first and second virtual curves.

FIG. 12 shows a fourth example of the shape of the gas guide surface extending between the first and second virtual curves.

FIG. 13 shows construction of a fifth example of the shape of the gas guide surface extending between the first and second virtual curves.

FIG. 14 shows the fifth example of the shape of the gas guide surface obtained from FIG. 13.

FIG. 15 shows a first example of a first section over which the gas guide surface extends.

FIG. 16 shows a second example of the first section over which the gas guide surface extends.

FIG. 17 shows a third example of the first section over which the gas guide surface extends.

FIG. 18 shows a fourth example of the first section over which the gas guide surface extends.

FIG. 19 shows a return acoustic wave that may be reflected by a guide portion in the laser device of the first embodiment.

FIG. 20 shows stagnation of the laser gas that may occur in the vicinity of the guide portion in the laser device of the first embodiment.

FIG. 21 shows the configuration of a part of the laser device according to a second embodiment viewed in the −Z direction.

FIG. 22 shows third and fourth virtual curves.

FIG. 23 shows the surface positions along the flow path of the laser gas in the second embodiment.

FIG. 24 shows a first example of a third section over which the guide surface extends.

FIG. 25 shows a second example of the third section over which the guide surface extends.

FIG. 26 shows a third example of the third section over which the guide surface extends.

FIG. 27 shows the configuration of an exposure system.

### DESCRIPTION OF EMBODIMENTS

### <Contents>

1. Comparative example
   1.1 Configuration
   1.2 Operation
2. Problem of comparative example
3. Laser chamber 10 with inner surface having shape in which curvature thereof decreases along flow direction of laser gas
   3.1 Gas guide surface 18 having logarithmic spiral shape
   3.2 Gas guide surface 18 including combination of plurality of arcs
   3.3 Gas guide surface 18 including part of ellipse
   3.4 Gas guide surface 18 including combination of plurality of arcs and external common tangents
   3.5 Section over which gas guide surface 18 extends
   3.6 Effect
4. Shape of guide portion 28
   4.1 Return acoustic wave and stagnation in first embodiment
   4.2 Guide portion 28 with guide surface 281 having shape in which curvature thereof decreases along flow direction of laser gas
   4.3 Section over which guide surface 281 extends
   4.4 Effect
5. Others
   5.1 Electronic device manufacturing method
   5.2 Laser control processor 30
   5.3 Supplement

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Comparative Example

### 1.1 Configuration

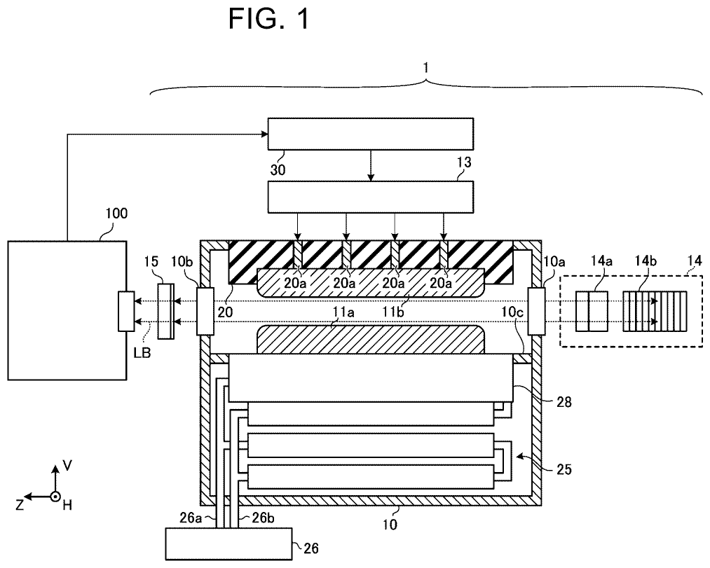

FIG. 1 shows the configuration of a laser device 1 of a comparative example. The comparative example of the present disclosure is an example recognized by the applicant as known only by the applicant, and is not a publicly known example admitted by the applicant.

The laser device 1 is a discharge-excitation-type gas laser device capable of outputting laser light LB to an exposure apparatus 100. The laser device 1 includes a laser chamber 10 including first and second discharge electrodes 11a, 11b, a power source device 13, a line narrowing module 14, an output coupling mirror 15, and a laser control processor 30. The line narrowing module 14 and the output coupling mirror 15 configure an optical resonator. The laser chamber 10 includes windows 10a, 10b, and is arranged such that the windows 10a, 10b are located on the optical path of the optical resonator. The laser control processor 30 will be described later.

The travel direction of the laser light LB output from the output coupling mirror 15 is represented by a Z direction. Each of the first and second discharge electrodes 11a, 11b extends in the Z direction. The direction in which the first and second discharge electrodes 11a, 11b face each other is defined as a V direction or a −V direction. The Z direction and the V direction are perpendicular to each other, and the direction perpendicular to both of them is represented by an H direction or a −H direction. The V direction and the Z direction correspond to the first and second directions in the present disclosure, respectively. In FIG. 1, the configuration of the laser device 1 is shown as viewed in the −H direction.

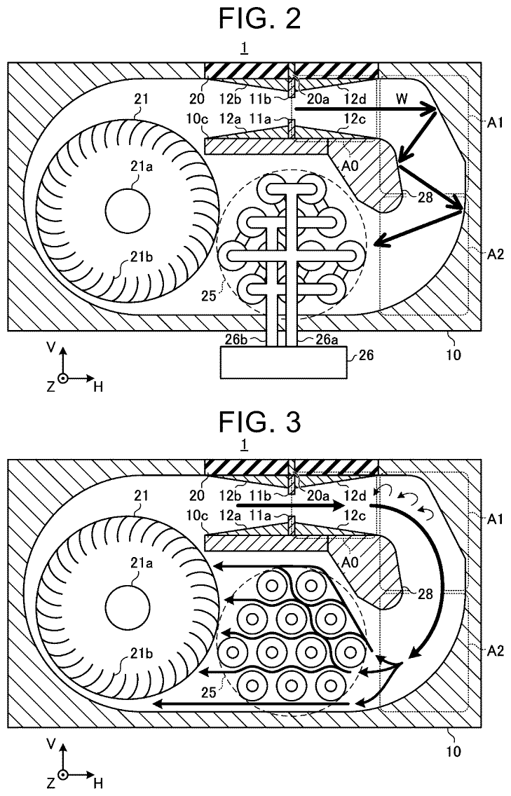

FIG. 2 shows the configuration of a part of the laser device 1 according to the comparative example viewed in the −Z direction. The laser chamber 10 accommodates the first and second discharge electrodes 11a, 11b, inclined members 12a to 12d, a cross flow fan 21, a cooling unit 25, and a guide portion 28.

The laser chamber 10 is filled with a laser gas containing, for example, an argon gas or a krypton gas as a rare gas, a fluorine gas as a halogen gas, a neon gas as a buffer gas, and the like. Alternatively, a laser gas containing a fluorine gas and a buffer gas may be enclosed.

An opening is formed in a part of the laser chamber 10, which is closed by an electrically insulating portion 20. The electrically insulating portion 20 supports the second discharge electrode 11b. A plurality of conductive portions 20a are embedded in the electrically insulating portion 20. Each of the conductive portions 20a is electrically connected to the second discharge electrode 11b. The power source device 13 includes a charger (not shown) and is connected to the second discharge electrode 11b via the conductive portions 20a. Each of the inclined members 12b, 12d has a triangular prism shape, and is fixed to the electrically insulating portion 20 so as to cover a part of two side surfaces of the second discharge electrode 11b.

A return plate 10c is arranged in the laser chamber 10. The first discharge electrode 11a is supported by the return plate 10c. The first discharge electrode 11a is electrically connected to the ground potential via the return plate 10c and a conductive member of the laser chamber 10. As shown in FIG. 2, the return plate 10c defines a gap through which the laser gas passes on each of the front and back sides of the paper surface of FIG. 1. Each of the inclined members 12a, 12c has a triangular prism shape and is fixed to the return plate 10c so as to cover a part of two side surfaces of the first discharge electrode 11a. The inclined members 12a, 12c may include porous members for reducing acoustic waves generated at a discharge space between the first and second discharge electrodes 11a, 11b.

The inclined members 12a, 12b are arranged to gradually narrow the flow path of the laser gas so as to efficiently guide the laser gas fed from the cross flow fan 21 to the discharge space between the first and second discharge electrodes 11a, 11b. The inclined members 12c, 12d are arranged to gradually expand the flow path of the laser gas so as to efficiently guide the laser gas having passed through the discharge space in a direction of approaching the guide portion 28.

The cross flow fan 21 includes a plurality of blades 21b arranged around a rotation shaft 21a. The rotation shaft 21a is connected to a motor (not shown). The cross flow fan 21 corresponds to the fan in the present disclosure.

The cooling unit 25 includes a plurality of refrigerant pipes and heat radiation fins arranged around each of the refrigerant pipes. Each of the refrigerant pipes is arranged such that the longitudinal direction thereof extends in the Z direction. The refrigerant pipes are connected to a heat exchanger 26 via pipes 26a, 26b.

The guide portion 28 is fixed to the inclined member 12c so as to guide the laser gas having passed between the inclined members 12c, 12d to the cooling unit 25.

The line narrowing module 14 includes a prism 14a and a grating 14b. The prism 14a is arranged on the optical path of light output through the window 10a. The grating 14b is arranged on the optical path of the light having transmitted through the prism 14a. The output coupling mirror 15 is configured by a partial reflection mirror.

### 1.2 Operation

The laser control processor 30 receives a target value of a pulse energy E and a light emission trigger signal from the exposure apparatus 100. The laser control processor 30 transmits setting data of a charge voltage to the charger included in the power source device 13 based on the target value of the pulse energy E. Further, the laser control processor 30 transmits a trigger signal to the power source device 13 based on the light emission trigger signal.

Upon receiving the trigger signal from the laser control processor 30, the power source device 13 generates a pulse high voltage from the electric energy charged to the charger and applies the high voltage between the first and second discharge electrodes 11a, 11b.

When the high voltage is applied between the first and second discharge electrodes 11a, 11b, discharge occurs between the first and second discharge electrodes 11a, 11b. The laser medium in the laser chamber 10 is excited by the energy of the discharge and shifts to a high energy level. When the excited laser medium then shifts to a low energy level, light having a wavelength corresponding to the difference between the energy levels is emitted.

The light generated in the laser chamber 10 is output to the outside of the laser chamber 10 through the windows 10a, 10b. The beam width in the H direction of the light output through the window 10a of the laser chamber 10 is expanded by the prism 14a, and then the light is incident on the grating 14b.

The light incident on the grating 14b is reflected by a plurality of grooves of the grating 14b and is diffracted in a direction corresponding to the wavelength of the light. By matching the incident angle of the light incident on the grating 14b with the diffraction angle of the diffracted light having a desired wavelength, the wavelength of the diffracted light incident on the prism 14a from the grating 14b is selected. The prism 14a reduces the beam width in the H direction of the diffracted light incident thereon from the grating 14b and returns the light to the laser chamber 10 through the window 10a.

The output coupling mirror 15 transmits and outputs a part of the light output through the window 10b of the laser chamber 10, and reflects the other part back into the laser chamber 10.

In this way, the light output from the laser chamber 10 reciprocates between the line narrowing module 14 and the output coupling mirror 15, and is amplified each time the light passes through the discharge space between the first and second discharge electrodes 11a, 11b. The light is line narrowed each time being turned back in the line narrowing module 14. Thus, the light having undergone laser oscillation and line narrowing is output as the laser light LB from the output coupling mirror 15.

It is assumed that the flow path of the laser gas passing through the discharge space and directed toward the cooling unit 25 includes three regions from the upstream side in the flow direction of the laser gas in this order: a straight region A0, a first corner region A1, and a second corner region A2. The straight region A0 is a region sandwiched between the inclined members 12c, 12d, the first corner region A1 is a region where the gas flow changes from the H direction to the −V direction, and the second corner region A2 is a region where the gas flow changes from the −V direction to the −H direction.

In synchronization with discharge occurring between the first and second discharge electrodes 11a, 11b, the gas in the discharge space is excited and heated. The discharge is repeated in synchronization with the trigger signal having a repetition frequency f, and generates a compression wave of the gas. The compression wave propagates through the space in the laser chamber 10. The compression wave is referred to as an acoustic wave W. The acoustic wave W impinges on components in the laser chamber 10 and is reflected. The acoustic wave returning to the discharge space among the reflected acoustic waves W is referred to as a return acoustic wave. The return acoustic wave causes the density of the laser gas in the discharge space to be uneven, which causes uneven refractive index distribution and uneven light intensity distribution of the light reciprocating through the optical resonator. Therefore, the quality of the laser light LB may be deteriorated.

To suppress the return acoustic wave, in the comparative example, the inner surface of the laser chamber 10 on which the acoustic wave W propagating in the H direction from the discharge space impinges has an oblique planar shape. Accordingly, most of the acoustic waves W is reflected in a direction including direction components in the −V direction, and propagates from the first corner region A1 to the cooling unit 25 via the second corner region A2.

FIG. 3 shows the flow of the laser gas in the comparative example. The components shown in FIG. 3 are the same as those in FIG. 2, but the pipes 26a, 26b and the heat exchanger 26 are not shown.

When the motor (not shown) rotates the cross flow fan 21, the laser gas flows and circulates through the inside of the laser chamber 10 as indicated by arrows in FIG. 3. Discharge products generated by the discharge between the first and second discharge electrodes 11a, 11b are removed from the discharge space by the flow of the laser gas by the time of the subsequent discharge, and the discharge space and the vicinity thereof are in a state in which there is little discharge products, so that the discharge can be stabilized.

The cooling unit 25 cools the laser gas by absorbing the thermal energy of the laser gas that has reached a high temperature due to the discharge. The thermal energy is discharged to the outside of the laser chamber 10 through a refrigerant.

### 2. Problem of Comparative Example

In FIG. 3, the relative magnitude of the flow velocity of the laser gas is represented by the thickness of the arrows. The laser gas having passed between the first and second discharge electrodes 11a, 11b and between the inclined members 12c, 12d in the H direction passes through the flow path between the inner surface of the laser chamber 10 and the guide portion 28, and thus the flow direction of the laser gas is rotated about an axis parallel to the Z direction, and is guided to the cooling unit 25. As a result of simulating the flow of the laser gas, it was found that stagnation staying in the vicinity of the inner surface of the laser chamber 10 at the first corner region A1 occurs in addition to a main flow flowing as a laminar flow in the vicinity of a center line of the flow path of the laser gas. The stagnation is considered to occur because a later described surface position D+ of the inner surface of the laser chamber 10 defining the flow path of the laser gas steeply changes at the first corner region A1.

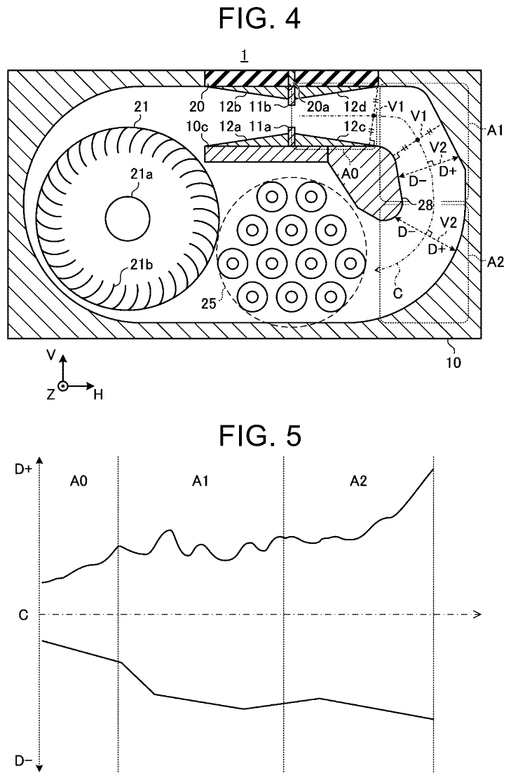

FIG. 4 shows the definition of surface positions D−, D+. As shown in FIG. 4, when a plurality of virtual perpendicular lines V1 perpendicular to the respective surfaces of the inclined member 12c and the guide portion 28 facing the laser gas flow path are drawn from the respective positions of the surface to the inclined member 12d or the inner surface of the laser chamber 10, a curve formed by connecting the midpoints of the virtual perpendicular lines V1 is defined as a flow path center line C.

When virtual perpendicular lines V2 perpendicular to the flow path center line C are drawn, a distance along the virtual perpendicular line V2 from each position of the flow path center line C to the surface of the inclined member 12c or the guide portion 28 is defined as the surface position (distance) D−, and a distance along the virtual perpendicular line V2 from each position of the flow path center line C to the inclined member 12d or the inner surface of the laser chamber 10 is defined as the surface position (distance) D+. A distance along the flow path center line C from the discharge region to the virtual perpendicular line V2 is defined as a distance from the discharge region.

FIG. 5 shows the surface positions D−, D+ along the flow path of the laser gas in the comparative example. The horizontal axis represents the distance from the discharge region. The surface position D− of the inclined member 12c or the guide portion 28 is represented by a negative number. In the first corner region A1, the surface position D+ of the inner surface of the laser chamber 10 has a steep uneven shape. When the curvature of the inner surface of the laser chamber 10 steeply changes, such a steep uneven shape is obtained. It is presumed that the laser gas flowing along such an inner surface of the laser chamber 10 is separated from the inner surface of the laser chamber 10 and becomes turbulent, so that stagnation occurs. Since such stagnation gives flow path resistance to the main flow of the laser gas, it is necessary to increase the number of revolutions of the cross flow fan 21 to obtain a sufficient flow rate, which increases energy consumption. If the number of revolutions of the cross flow fan 21 is not increased, a sufficient flow rate cannot be obtained, and discharge may become unstable with discharge products not being completely removed from the discharge space.

Further, at each portion of the inner surface of the laser chamber 10 where the curvature steeply changes, the acoustic wave W is reflected in multiple directions, and a part thereof may return to the discharge space as the return acoustic wave. Even if the intensity of the return acoustic wave returning from each portion to the discharge space is small, the intensity may not be negligible when they are combined, and the quality of the laser light LB may be deteriorated.

Embodiments described below relate to providing a discharge-excitation-type gas laser device that suppresses separation of the laser gas from the inner surface of the laser chamber 10 to improve the flow of the laser gas and suppress deterioration of the quality of the laser light LB.

### 3. Laser Chamber 10 with Inner Surface Having Shape in which Curvature Thereof Decreases Along Flow Direction of Laser Gas

### 3.1 Gas Guide Surface 18 Having Logarithmic Spiral Shape

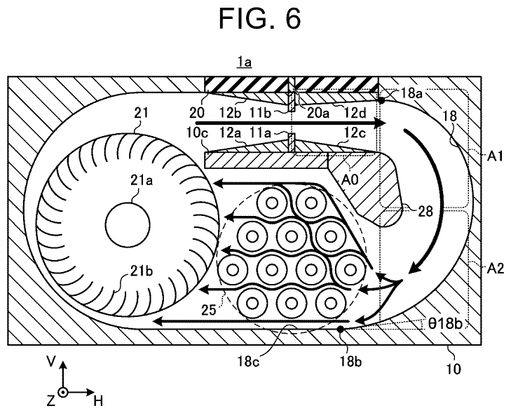

FIG. 6 shows the configuration of a part of a laser device 1a according to a first embodiment viewed in the −Z direction. The laser device 1a is different from that of the comparative example in the shape of the inner surface of the laser chamber 10. In FIG. 6, the pipes 26a, 26b and the heat exchanger 26 are not shown. The inner surface of the laser chamber 10 includes a gas guide surface 18 defining the flow path of the laser gas from a position where the laser gas passes between the first and second discharge electrodes 11a, 11b to a position where the laser gas reaches the vicinity of the cooling unit 25, and a planar portion 18c in the vicinity of the cooling unit 25 on the downstream side of the gas guide surface 18. The gas guide surface 18 is a curved surface extending from a first position 18a which is an end portion in the V direction on the upstream side in the flow direction of the laser gas to a second position 18b which is an end portion in the −V direction on the downstream side.

An angle θ18b formed between a tangent line in the vicinity of the second position 18b of the gas guide surface 18 and the planar portion 18c is 0° or more and less than 45°. The gas guide surface 18 extends between first and second virtual curves L1, L2 described below when viewed in cross-section in a plane perpendicular to the Z direction.

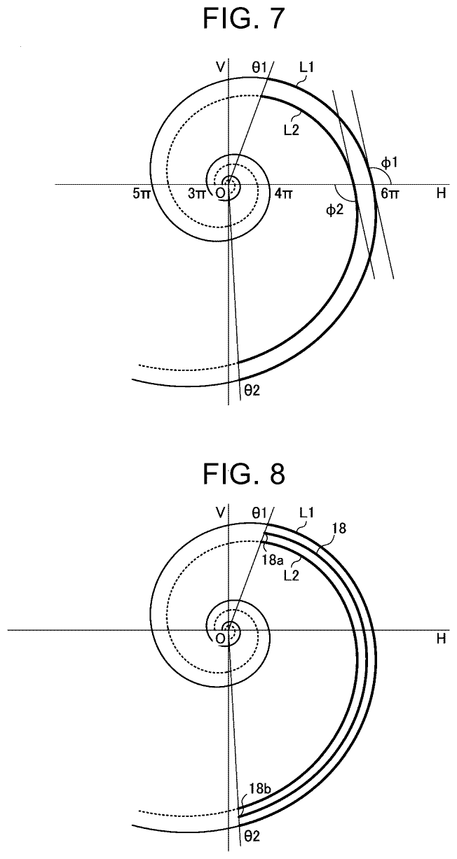

FIG. 7 shows the first and second virtual curves L1, L2. Each of the first and second virtual curves L1, L2 is a curve in which the curvature decreases along the flow direction. The first virtual curve L1 is a part from a first phase angle θ1 to a second phase angle θ2 of a first virtual logarithmic spiral having an angle φ1 of 103° at which a straight line from a first origin O and a tangent line of the first virtual curve L1 intersect each other. The second virtual curve L2 is a part from the first phase angle θ1 to the second phase angle θ2 of a second virtual logarithmic spiral having an angle φ2 of 96° at which a straight line from the first origin O and a tangent line of the second virtual curve L2 intersect each other. In the first and second virtual curves L1, L2, the angles φ1, φ2 differ from each other, but the first origin O and the first and second phase angles θ1, θ2 are the same. The angle difference θ2−θ1 between the first and second phase angles θ1, θ2 is preferably 90° or more and 180° or less.

FIG. 8 shows a first example of the shape of the gas guide surface 18 extending between the first and second virtual curves L1, L2. The gas guide surface 18 may have a logarithmic spiral shape, and the angle at which a straight line from the origin of the logarithmic spiral and a tangent line of the logarithmic spiral intersect each other may be, for example, 99°. Here, the origin of the logarithmic spiral configuring the gas guide surface 18 may not be common to the origin O of the first and second virtual logarithmic spirals. Further, the gas guide surface 18 may not have a perfect logarithmic spiral shape. By forming the gas guide surface 18 to extend between the first and second virtual curves L1, L2, a shape in which the curvature thereof decreases along the flow direction can be obtained.

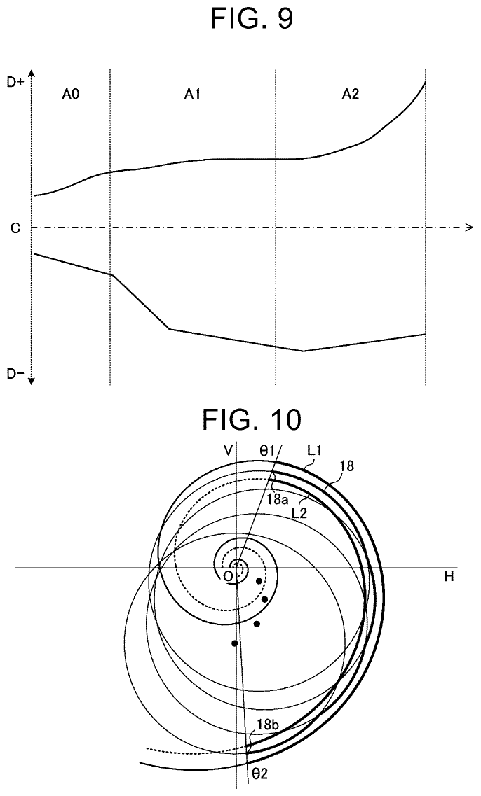

FIG. 9 shows the surface positions D−, D+ along the flow path of the laser gas in the first embodiment. In the first embodiment, there is no steep uneven shape at the first corner region A1 as in the comparative example, and the surface position n D+ monotonically increases from the upstream side toward the downstream side in the flow direction. With such a shape, it is possible to suppress occurrence of stagnation in the vicinity of the inner surface of the laser chamber 10. Further, the return acoustic wave returning to the discharge space is reduced.

### 3.2 Gas Guide Surface 18 Including Combination of Plurality of Arcs

FIG. 10 shows a second example of the shape of the gas guide surface 18 extending between the first and second virtual curves L1, L2. The gas guide surface 18 may include a combination of a plurality of arcs having different centers. The center of each arc is indicated by a black circle. The radii of the arcs may be equal to each other. The number of the arcs may be three or more.

FIG. 11 shows a third example of the shape of the gas guide surface 18 extending between the first and second virtual curves L1, L2. The gas guide surface 18 may include a combination of a plurality of arcs having different centers and radii increasing along the flow direction.

### 3.3 Gas Guide Surface 18 Including Part of Ellipse

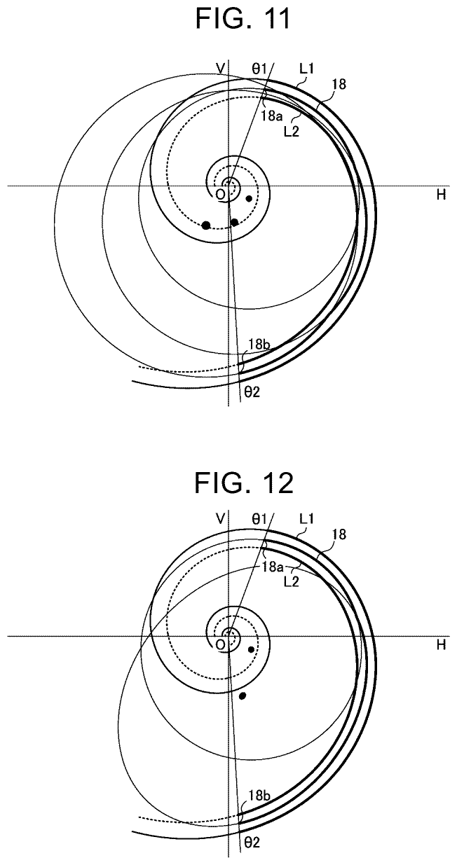

FIG. 12 shows a fourth example of the shape of the gas guide surface 18 extending between the first and second virtual curves L1, L2. The gas guide surface 18 may include a part of an ellipse that changes in curvature along the flow direction. An arc may be included in addition to an ellipse. There may be a plurality of ellipses or arcs. Instead of an ellipse, a quadratic curve other than an ellipse may be used.

### 3.4 Gas Guide Surface 18 Including Combination of Plurality of Arcs and External Common Tangents

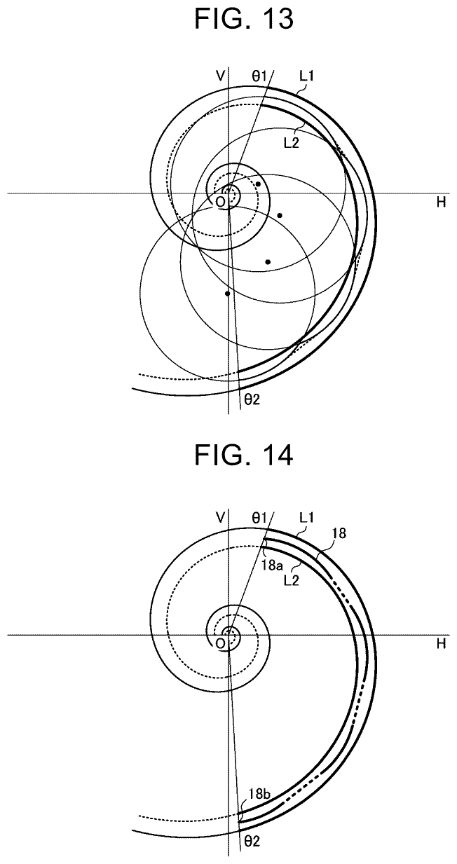

FIG. 13 shows construction of a fifth example of the shape of the gas guide surface 18 extending between the first and second virtual curves L1, L2, and FIG. 14 shows the fifth example of the shape of the gas guide surface 18 obtained from FIG. 13. The gas guide surface 18 may include a combination of a plurality of arcs having different centers and external common tangents thereof. Three or more arcs may be included, and in this case, the external common tangents may only be each external common tangents of arcs whose centers are adjacent to each other.

3.5 Section Over which Gas Guide Surface 18 Extends

FIGS. 8 to 14 describe a case in which the gas guide surface 18 extends over the entire first and second virtual curves L1, L2 from the first phase angle θ1 to the second phase angle θ2. The section from the first phase angle θ1 to the second phase angle θ2 over which the gas guide surface 18 extends corresponds to the second section in the present disclosure. In FIGS. 8 to 14, the first position 18a coincides with the position corresponding to the first phase angle θ1, and the second position 18b coincides with the position corresponding to the second phase angle θ2. The present disclosure is not limited thereto, and the gas guide surface 18 is simply required to extend over a first section corresponding to a phase angle of a magnitude of 90° or more of the virtual logarithmic spiral of the first and second virtual curves L1, L2. The first section is a section within the second section.

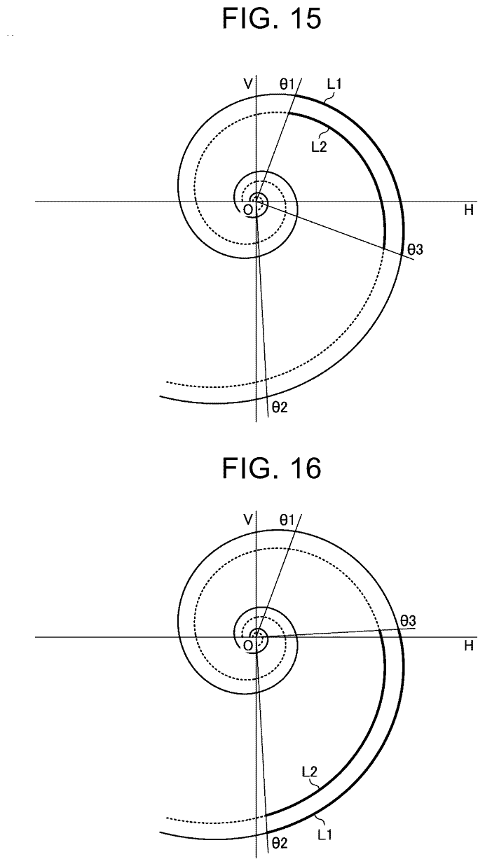

FIG. 15 shows a first example of the first section over which the gas guide surface 18 extends. The gas guide surface 18 may extend over the first section from the first phase angle θ1 to a third phase angle θ3 which is an angle between the first and second phase angles θ1, θ2. The first position 18a may coincide with the position corresponding to the first phase angle θ1.

FIG. 16 shows a second example of the first section over which the gas guide surface 18 extends. The gas guide surface 18 may extend over the first section from the third phase angle θ3, which is an angle between the first and second phase angles θ1, θ2, to the second phase angle θ2. The second position 18b may coincide with the position corresponding to the second phase angle θ2.

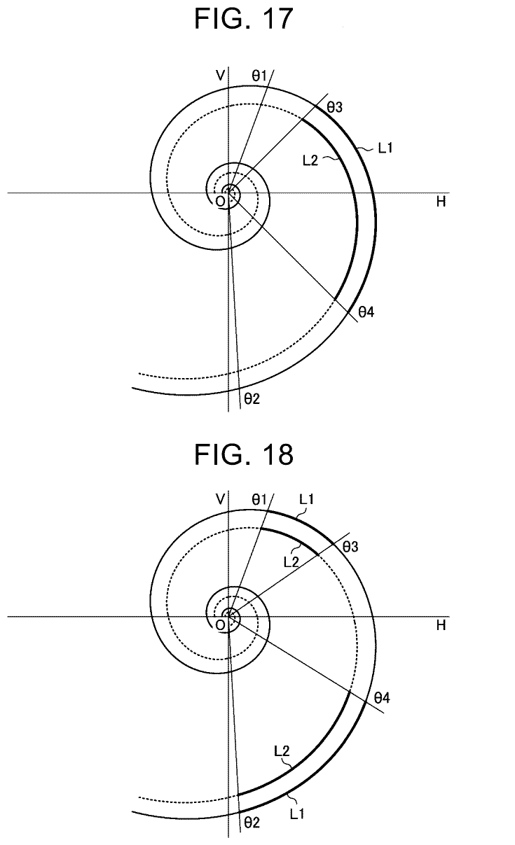

FIG. 17 shows a third example of the first section over which the gas guide surface 18 extends. The gas guide surface 18 may extend over the first section from the third phase angle θ3, which is an angle between the first and second phase angles θ1, θ2, to a fourth phase angle θ4 which is an angle between the third and second phase angles θ3, θ2.

Although a case in which the first section is a continuous section has been described in FIGS. 8 to 17, the present disclosure is not limited thereto. The first section may include a plurality of discontinuous sections within the second section, and the sum of the magnitudes of the phase angles is simply required to be 90° or more.

FIG. 18 shows a fourth example of the first section over which the gas guide surface 18 extends. The gas guide surface 18 may extend over the first section including a section from the first phase angle θ1 to a third phase angle θ3, which is an angle between the first and second phase angles θ1, θ2, and a section from a fourth phase angle θ4, which is an angle between the third and second phase angles θ3, θ2, to the second phase angle θ2. The first position 18a may coincide with the position corresponding to the first phase angle θ1, and the second position 18b may coincide with the position corresponding to the second phase angle θ2. The first section may include three or more discontinuous sections.

In FIGS. 15 to 18, it is preferable that the portion of the gas guide surface 18 extending over the first section includes at least a part of the portion of the gas guide surface 18 defining the first corner region A1. The examples of FIGS. 15, 17, and 18 are more desirable because the portion extending over the first section includes much of the portion defining the first corner region A1.

### 3.6 Effect

(1) According to the first embodiment, the laser chamber 10 of the discharge-excitation-type gas laser device includes the first and second discharge electrodes 11a, 11b, the cross flow fan 21, and the cooling unit 25. The first and second discharge electrodes 11a, 11b are arranged in the laser chamber 10 facing each other in a direction parallel to the V direction, and each of the first and second discharge electrodes 11a, 11b extends in the Z direction perpendicular to the V direction. The cross flow fan 21 is arranged in the laser chamber 10, and causes the laser gas in the laser chamber 10 to circulate while rotating the flow direction of the laser gas about an axis parallel to the z direction. The cooling unit 25 is arranged in the laser chamber 10 and cools the laser gas. When the laser chamber 10 is viewed in cross-section in a plane perpendicular to the Z direction, at least a part of the gas guide surface 18 out of the inner surface of the laser chamber 10 extends between (a) and (b) described below over the first section corresponding to a phase angle of a magnitude of 90° or more of the first and second virtual logarithmic spirals. Here, the part of the gas guide surface is a part from the first position 18a on the upstream side in the flow direction of the laser gas to the second position 18b on the downstream side therein and the inner surface of the laser chamber 10 defines the flow path of the laser gas through which the laser gas flows between the first and second discharge electrodes 11a, 11b to the vicinity of the cooling unit 25.
(a) The first virtual curve L1 having a curvature decreasing along the flow direction, and extending from the first phase angle θ1 to the second phase angle θ2 of the first virtual logarithmic spiral having the angle φ1 of 103° at which a straight line from the first origin O and a tangent line of the first virtual curve L1 intersect each other.
(b) The second virtual curve L2 having a curvature decreasing along the flow direction, and extending from the first phase angle θ1 to the second phase angle θ2 of the second virtual logarithmic spiral having the angle @2 of 96° at which a straight line from the first origin O and a tangent line of the second virtual curve L2 intersect each other.

According to this configuration, by extending the gas guide surface 18 between the first and second virtual curves L1, L2 in which the curvature decreases along the flow direction, it is possible to suppress increase of the flow path resistance due to occurrence of stagnation of the laser gas in the vicinity of the gas guide surface 18. Further, it is possible to suppress deterioration of the quality of the laser light LB due to the acoustic wave W being reflected by the gas guide surface 18 and returning to the discharge space.

(2) According to the second and third examples of the shape of the gas guide surface 18 in the first embodiment, when viewed in cross-section in a plane perpendicular to the Z direction, the gas guide surface 18 includes a combination of a plurality of arcs having different centers.

According to this configuration, by configuring the gas guide surface 18 by combining the plurality of arcs, it is possible to improve the flow of the laser gas and to suppress the return acoustic wave with a shape that is easy to be manufactured.

(3) According to the third example of the shape of the gas guide surface 18 in the first embodiment, when viewed in cross-section in a plane perpendicular to the Z direction, the gas guide surface 18 includes a combination of a plurality of arcs having different centers and radii increasing along the flow direction.

According to this configuration, by increasing the radii of the arcs along the flow direction, a part of the gas guide surface 18 can have a shape close to a logarithmic spiral in which the curvature decreases along the flow direction. Further, it is possible to reduce the number of combined arcs to make it easier to be manufactured.

(4) According to the fourth example of the shape of the gas guide surface 18 in the first embodiment, when viewed in cross-section in a plane perpendicular to the Z direction, the gas guide surface 18 includes a part of an ellipse in which the curvature changes along the flow direction.

According to this configuration, since the ellipse has a large curvature in the vicinity of the end portion of the major axis and the curvature decreases toward the vicinity of the end portion of the minor axis, it is possible to have a shape close to a logarithmic spiral in which the curvature decreases along the flow direction in a part of the gas guide surface 18 by using a part of the ellipse.

(5) According to the fifth example of the shape of the gas guide surface 18 in the first embodiment, when viewed in cross-section in a plane perpendicular to the Z direction, the gas guide surface 18 includes a combination of a plurality of arcs having different centers and external common tangents thereof.

According to this configuration, by combining the plurality of arcs and external common tangents, a concave portion in the vicinity of an intersection of the plurality of arcs can be made straight, and it is possible to improve the flow of the laser gas and suppress the return acoustic wave.

(6) According to the fifth example of the shape of the gas guide surface 18 in the first embodiment, when viewed in cross-section in a plane perpendicular to the Z direction, the gas guide surface 18 includes a combination of three or more arcs having different centers and external common tangents of arcs whose centers are adjacent to each other.

According to this configuration, by combining the three or more arcs, it is possible to improve the flow of the laser gas over a wide range in the flow direction and suppress the return acoustic wave.

(7) According to the first embodiment, the first position 18a and the second position 18b are one end portion in the V direction and the other end portion in the V direction of the inner surface of the laser chamber 10, respectively.

According to this configuration, the flow of the laser gas over the entire inner surface of the laser chamber 10 in the V direction can be improved and the return acoustic wave can be suppressed.

(8) According to some examples in the first embodiment, the gas guide surface 18 extends over the second section including the first section, the second section corresponding to a section of the first and second virtual logarithmic spirals from the first phase angle θ1 to the second phase angle θ2.

According to this configuration, it is possible to improve the flow of the laser gas over a wide range in the flow direction and suppress the return acoustic wave.

(9) According to some examples in the first embodiment, the first position 18a coincides with the position corresponding to the first phase angle θ1 and the second position 18b coincides with the position corresponding to the second phase angle θ2.

According to this configuration, it is possible to improve the flow of the laser gas over the entire gas guide surface 18 and suppress the return acoustic wave.

(10) According to the first example of the first section in the first embodiment, the first section is a section from the first phase angle θ1 to the third phase angle θ3, which is an angle between the first and second phase angles θ1, θ2, and the first position 18a coincides with the position corresponding to the first phase angle θ1.

According to this configuration, it is possible to improve the flow of the laser gas in the first section from the first phase angle θ1 corresponding to the first position 18a to the third phase angle θ3, and suppress the acoustic wave.

(11) According to the second example of the first section in the first embodiment, the first section is a section from the third phase angle θ3, which is an angle between the first and second phase angles θ1, θ2, to the second phase angle θ2, and the second position 18b coincides with the position corresponding to the second phase angle θ2.

According to this configuration, it is possible to improve the flow of the laser gas in the first section from the third phase angle θ3 to the second phase angle θ2 corresponding to the second position 18b, and suppress the acoustic wave.

(12) According to the first to third examples of the first section in the first embodiment, the first section is a continuous section.

According to this configuration, it is possible to improve the flow of the laser gas in a continuous section of 90° or more, and suppress the return acoustic wave.

(13) According to the fourth example of the first section in the first embodiment, the first section includes a plurality of discontinuous sections whose sum of the magnitudes of the phase angles is 90° or more.

According to this configuration, by making the sum of the plurality of discontinuous sections to be 90° or more, it is possible to improve the flow of the laser gas and suppress the return acoustic wave.

(14) According to the fourth example of the first section in the first embodiment, the first section includes the section from the first phase angle θ1 to the third phase angle θ3, which is an angle between the first and second phase angles θ1, θ2, and the section from the fourth phase angle θ4, which is an angle between the third and second phase angles θ3, θ2, to the second phase angle θ2, the first position 18a coincides with the position corresponding to the first phase angle θ1, and the second position 18b coincides with the position corresponding to the second phase angle θ2.

According to this configuration, it is possible to improve the flow of the laser gas at both in the vicinity of the first position 18a and in the vicinity of the second position 18b, and suppress the return acoustic wave.

(15) According to the first embodiment, the inner surface of the laser chamber 10 includes the planar portion 18c in the vicinity of the cooling unit 25, and the angle θ18b formed between a tangent line at the second position 18b of the gas guide surface 18 and the planar portion 18c is less than 45° when the laser chamber 10 is viewed in a cross-section in a plane perpendicular to the Z direction.

According to this configuration, it is possible to improve the gas flow in the vicinity of the second position 18b and suppress the return acoustic wave.

In other respects, the first embodiment is similar to the comparative example.

### 4. Shape of Guide Portion 28

### 4.1 Return Acoustic Wave and Stagnation in First Embodiment

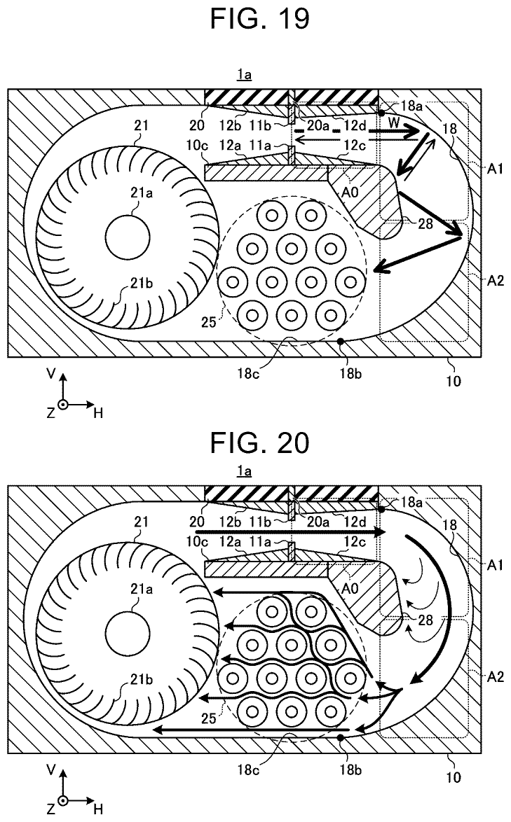

FIG. 19 shows the acoustic wave that may be reflected by the guide portion 28 in the laser device 1a of the first embodiment. An acoustic wave W is reflected in multiple directions at each portion where the curvature of the surface of the guide portion 28 steeply changes, and a part thereof may return to the discharge space as the return acoustic wave, so that there is a possibility that the quality of the laser light LB is deteriorated.

FIG. 20 shows stagnation of the laser gas that may occur in the vicinity of the guide portion 28 in the laser device 1a of the first embodiment. When the curvature of the surface of the guide portion 28 steeply changes, the laser gas that is supposed to flow along the surface of the guide portion 28 is separated from the surface of the guide portion 28 and becomes turbulent, so that there is a possibility that stagnation occurs and flow path resistance is given to the main flow of the laser gas.

4.2 Guide Portion 28 with Guide Surface 281 Having Shape in which Curvature Thereof Decreases Along Flow Direction of Laser Gas

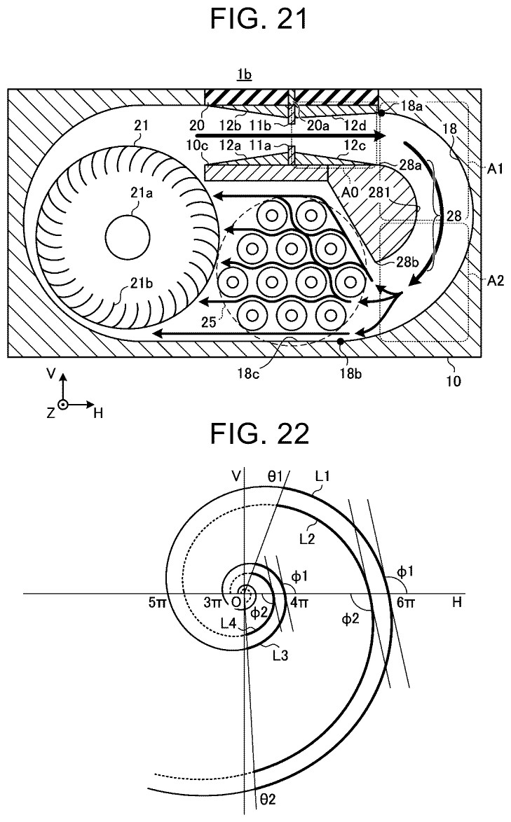

FIG. 21 shows the configuration of a part of a laser device 1b according to a second embodiment viewed in the −Z direction. In FIG. 21, the pipes 26a, 26b and the heat exchanger 26 are not shown. In the second embodiment, the guide portion 28 includes a guide surface front end 28a that is an end portion in the V direction on the upstream side in the flow direction of the laser gas, and a guide surface rear end 28b that is an end portion in the −V direction on the downstream side. The guide portion 28 includes a guide surface 281 extending from the guide surface front end 28a to the guide surface rear end 28b. The guide surface 281 faces the gas guide surface 18 and defines the flow path of the laser gas. The guide surface 281 extends between third and fourth virtual curves L3, L4 described below when viewed in cross-section in a plane perpendicular to the Z direction.

FIG. 22 shows the third and fourth virtual curves L3, L4. Each of the third and fourth virtual curves L3, L4 is a line that is located inside the bending direction of each of the first and second virtual curves L1, L2 and bends in the same direction as each of the first and second virtual curves L1, L2, and has a curvature that is greater than both the first and second virtual curves L1, L2. The third and fourth virtual curves L3, L4 may be a part of third and fourth virtual logarithmic spirals, respectively, and a second origin O of the third and fourth virtual logarithmic spirals may coincide with the first origin O of the first and second virtual logarithmic spirals configuring the first and second virtual curves L1, L2.

The third and fourth virtual curves L3, L4 may be similar to the first and second virtual curves L1, L2, respectively. The third virtual curve L3 may be a portion of the third virtual logarithmic spiral from the fifth phase angle to the sixth phase angle, and the fourth virtual curve L4 may be a portion of the fourth virtual logarithmic spiral from the fifth phase angle to the sixth phase angle. The fifth and sixth phase angles may be the same as the first and second phase angles θ1, θ2, respectively, and the fifth and sixth phase angles will be described below as the first and second phase angles θ1, θ2, respectively. The third and fourth virtual logarithmic spirals may be the same as the first and second virtual logarithmic spirals, respectively, and the third and fourth virtual curves L3, L4 may have a phase angle difference of 2π from the first and second virtual curves L1, L2, respectively.

With such a shape of the guide surface 281, as shown in FIG. 21, the flow of the laser gas is attracted to the guide surface 281 by the Coanda effect. By decreasing the curvature of the guide surface 281 along the flow direction, the Coanda effect is maintained over the entire length of the guide surface 281, and separation of the laser gas from the guide surface 281 and occurrence of stagnation associated therewith are suppressed. Further, since a portion where the curvature of the guide surface 281 steeply changes is reduced, the return acoustic wave is suppressed.

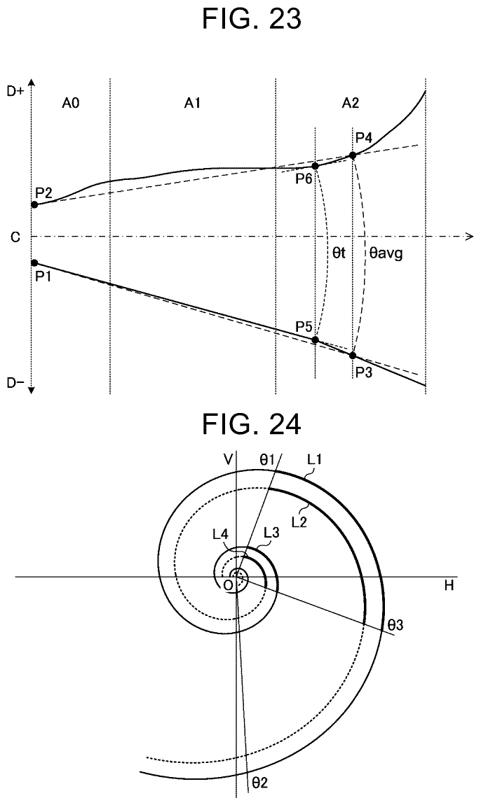

FIG. 23 shows the surface positions D−, D+ along the flow path of the laser gas in the second embodiment. In the second embodiment, the steep change is reduced not only at the surface position D+ of the inner surface of the laser chamber 10 but also at the surface position D− of the guide portion 28. With such a shape, it is possible to suppress occurrence of stagnation in the vicinity of the guide surface 281. Further, since the width of the flow path, which is the sum of the absolute value of the surface position D− and the surface position D+, gradually increases as the distance from the discharge region increases, even if the acoustic wave W is reflected in multiple directions, the width of the flow path gradually decreases in the path returning to the discharge space and the return acoustic wave reaching the discharge space is suppressed.

In FIG. 23, a point of the inclined member 12c corresponding to a position in contact with the first discharge electrode 11a is referred to as P1, and a point of the inclined member 12d corresponding to a position in contact with the second discharge electrode 11b is referred to as P2. Further, a point corresponding to the guide surface rear end 28b is referred to as P3, a point on the curve indicating the surface position D+ and having the distance from the discharge region being the same as P3, that is, a point corresponding to a position where the virtual perpendicular line V2 passing through the guide surface rear end 28b perpendicular to the flow path center line C intersects the gas guide surface 18 is referred to as P4. An angle θavg formed by a straight line connecting P1 and P3 and a straight line connecting P2 and P4 is preferably greater than 0° and equal to or less than 6°.

Further, an angle θt formed by a tangent line at an arbitrary point P5 between P1 and P3 on the curve indicating the surface position D− and a tangent line at a point P6 on the curve indicating the surface position D+ having the same distance from the discharge region as P5 is also preferably greater than 0° and equal to or less than 6°.

The guide surface 281 may have a logarithmic spiral shape. Alternatively, similarly to the shape of the gas guide surface 18 described with reference to FIGS. 10 to 14, a shape including a quadratic curve such as an arc or an ellipse or an external common tangent thereof may be used.

4.3 Section Over which Guide Surface 281 Extends

The guide surface 281 may extend over the entire third and fourth virtual curves L3, L4 from the first phase angle θ1 to the second phase angle θ2. The section from the first phase angle θ1 to the second phase angle θ2 in which the guide surface 281 extends corresponds to the fourth section in the present disclosure. For example, the guide surface front end 28a is located at a position corresponding to the first phase angle θ1, and the guide surface rear end 28b is located at a position corresponding to the second phase angle θ2. The present disclosure is not limited thereto, and the guide surface 281 is simply required to extend over a third section corresponding to a phase angle of a magnitude of 90° or more of the virtual logarithmic spiral of the third and fourth virtual curves L3, L4. The third section is a section within the fourth section.

FIG. 24 shows a first example of the third section over which the guide surface 281 extends. The guide surface 281 may extend over the third section from the first phase angle θ1 to the third phase angle θ3, which is an angle between the first and second phase angles θ1, θ2. The guide surface front end 28a may be located at a position corresponding to the first phase angle θ1.

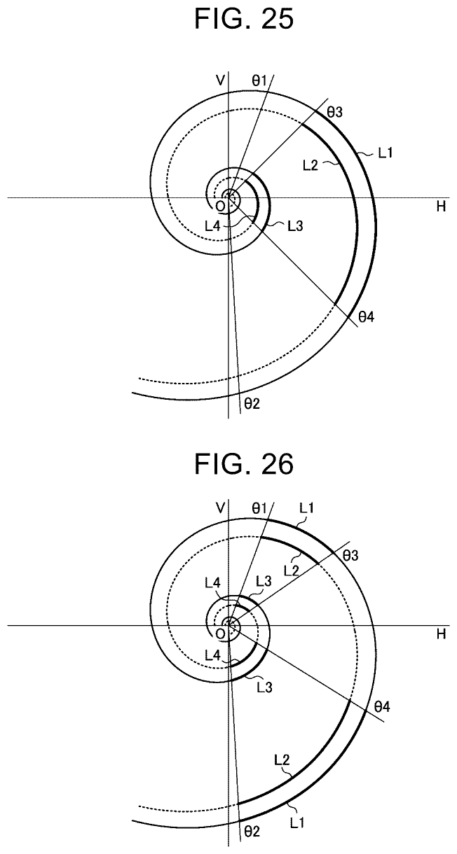

FIG. 25 shows a second example of the third section over which the guide surface 281 extends. The guide surface 281 may extend over the third section from the third phase angle θ3, which is an angle between the first and second phase angles θ1, θ2, to a fourth phase angle θ4, which is an angle between the third and second phase angles θ3, θ2.

Although a case in which the third section is a continuous section has been described in FIGS. 22 to 25, the present disclosure is not limited thereto. The third section may include a plurality of discontinuous sections within the fourth section, and the sum of the magnitudes of the phase angles is simply required to be 90° or more.

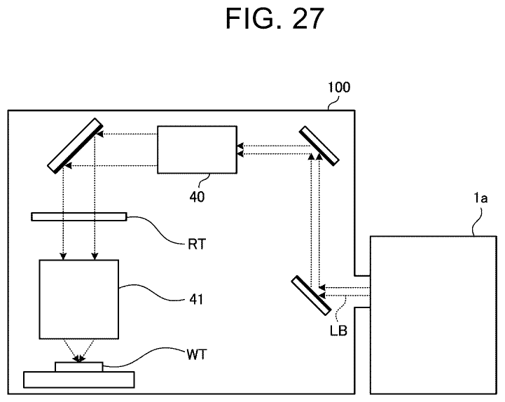

FIG. 26 shows a third example of the third section over which the guide surface 281 extends. The guide surface 281 may extend over the third section including a section from the first phase angle θ1 to a third phase angle θ3, which is an angle between the first and second phase angles θ1, θ2, and a section from a fourth phase angle θ4, which is an angle between the third and second phase angles θ3, θ2, to the second phase angle θ2. The guide surface front end 28a may be located at a position corresponding to the first phase angle θ1, and the guide surface rear end 28b may be located at a position corresponding to the second phase angle θ2. The third section may include three or more discontinuous sections.

### 4.4 Effect

According to the second embodiment, the laser chamber 10 includes the guide portion 28 including the guide surface 281 that faces the gas guide surface 18 and defines the flow path of the laser gas. When the laser chamber 10 is viewed in cross-section in a plane perpendicular to the Z direction, at least a part of the guide surface 281 extends between (a) and (b) described below over the third section corresponding to a phase angle of a magnitude of 90° or more of the third and fourth virtual logarithmic spirals.
(a) The third virtual curve L3 having a curvature decreasing along the flow direction, and extending from the fifth phase angle to the sixth phase angle of the third virtual logarithmic spiral having the angle φ1 of 103° at which a straight line from the second origin O and a tangent line of the third virtual curve L3 intersect each other.
(b) The fourth virtual curve L4 having a curvature decreasing along the flow direction, and extending from the fifth phase angle to the sixth phase angle of the fourth virtual logarithmic spiral having the angle φ2 of 96° at which a straight line from the second origin O and a tangent line of the fourth virtual curve L4 intersect each other.

According to this configuration, by not only extending the gas guide surface 18 between the first and second virtual curves L1, L2 at which the curvature decreases along the flow direction, but also extending the guide surface 281 between the third and fourth virtual curves L3, L4 at which the curvature decreases along the flow direction, it is possible to improve the flow of the laser gas in the vicinity of the guide surface 281 and suppress the return acoustic wave.

(17) According to the second embodiment, the first and second origins O coincide with each other.

According to this configuration, since the width of the flow path defined by the gas guide surface 18 and the guide surface 281 gradually increases as the distance from the discharge region increases, even if the acoustic wave W is reflected in multiple directions, the width of the flow path gradually decreases in the flow path returning to the discharge space, and the return acoustic wave is suppressed.

(18) According to the second embodiment, within the guide portion 28, the guide surface 281 from the guide surface front end 28a that is one end portion in the V direction on the upstream side in the flow direction to the guide surface rear end 28b that is the other end portion in the V direction on the downstream side extends over the fourth section including the third section, the fourth section corresponding to a section of the third and fourth virtual logarithmic spirals from the fifth phase angle to the sixth phase angle.

According to this configuration, it is possible to improve the flow of the laser gas over a wide range in the flow direction and suppress the return acoustic wave.

In other respects, the second embodiment is similar to the first embodiment.

### 5. Others

### 5.1 Electronic Device Manufacturing Method

FIG. 27 shows the configuration of an exposure system. The exposure system includes the laser device 1a and the exposure apparatus 100. The laser device 1a is configured to output the laser light LB toward the exposure apparatus 100. Instead of the laser device 1a, the laser device 1b may be used.

The exposure apparatus 100 includes an illumination optical system 40 and a projection optical system 41. The illumination optical system 40 illuminates a reticle pattern of a reticle (not shown) arranged on a reticle stage RT with the laser light LB incident from the laser device 1a. The projection optical system 41 causes the laser light LB transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 100 synchronously translates the reticle stage RT and the workpiece table WT to expose the workpiece to the laser light LB reflecting the reticle pattern. After the reticle pattern is transferred onto the semiconductor wafer by the exposure process described above, an electronic device can be manufactured through a plurality of processes.

### 5.2 Laser Control Processor 30

The laser control processor 30 may be physically configured as hardware to execute various processes included in the present disclosure. For example, the laser control processor 30 may be a computer including a memory that stores a control program defining the various processes and a processing device that executes the control program. The control program may be stored in one memory, or may be stored separately in a plurality of memories at physically separate locations, and the various processes may be defined by the control program as an aggregation thereof. The processing device may be a general-purpose processing device such as a CPU or a special-purpose processing device such as a GPU.

Alternatively, the laser control processor 30 may be programmed as software to execute the various processes included in the present disclosure. For example, the laser control processor 30 may be implemented in a dedicated device such as an ASIC or a programmable device such as an FPGA.

The various processes included in the present disclosure may be executed by one computer, one dedicated device, or one programmable device, or may be executed by cooperation of a plurality of computers, a plurality of dedicated devices, or a plurality of programmable devices at physically separate locations. The various processes may be executed by a combination including at least any two of: one or more computers, one or more dedicated devices, and one or more programmable devices.

### 5.3 Supplement

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser chamber of a discharge-excitation-type gas laser device, comprising:
first and second discharge electrodes arranged in the laser chamber as facing each other in a direction parallel to a first direction, each of the first and second discharge electrodes extending in a second direction perpendicular to the first direction;
a fan arranged in the laser chamber, and configured to cause a laser gas in the laser chamber to circulate while rotating a flow direction of the laser gas about an axis parallel to the second direction; and
a cooling unit arranged in the laser chamber, and configured to cool the laser gas,
when the laser chamber is viewed in cross-section in a plane perpendicular to the second direction, at least a part of a gas guide surface out of an inner surface of the laser chamber extending between first and second virtual curves over a first section corresponding to a phase angle of a magnitude of 90° or more of first and second virtual logarithmic spirals,
the part of the gas guide surface being a part from a first position on an upstream side in the flow direction of the laser gas to a second position on a downstream side therein,
the inner surface defining a flow path of the laser gas through which the laser gas flows between the first and second discharge electrodes to a vicinity of the cooling unit,
the first virtual curve having a curvature decreasing along the flow direction and being a virtual curve from a first phase angle to a second phase angle of the first virtual logarithmic spiral having an angle of 103° at which a straight line from a first origin and a tangent line of the first virtual curve intersect each other, and the second virtual curve having a curvature decreasing along the flow direction and being a virtual curve from the first phase angle to the second phase angle of the second virtual logarithmic spiral having an angle of 96° at which a straight line from the first origin and a tangent line of the second virtual curve intersect each other.

2. The laser chamber according to claim 1,
wherein, when viewed in cross-section in a plane perpendicular to the second direction, the gas guide surface includes a combination of a plurality of arcs having different centers.

3. The laser chamber according to claim 1,
wherein, when viewed in cross-section in a plane perpendicular to the second direction, the gas guide surface includes a combination of a plurality of arcs having different centers and radii increasing along the flow direction.

4. The laser chamber according to claim 1,
wherein, when viewed in cross-section in a plane perpendicular to the second direction, the gas guide surface includes a part of an ellipse in which a curvature changes along the flow direction.

5. The laser chamber according to claim 1,
wherein, when viewed in cross-section in a plane perpendicular to the second direction, the gas guide surface includes a combination of a plurality of arcs having different centers and external common tangents of the arcs.

6. The laser chamber according to claim 1,
wherein, when viewed in cross-section in a plane perpendicular to the second direction, the gas guide surface includes a combination of three or more arcs having different centers and external common tangents of the arcs whose centers are adjacent to each other.

7. The laser chamber according to claim 1,
wherein the first position and the second position are one end portion in the first direction and the other end portion in the first direction of the inner surface, respectively.

8. The laser chamber according to claim 7,
wherein the gas guide surface extends over a second section including the first section, the second section corresponding to a section of the first and second virtual logarithmic spirals from the first phase angle to the second phase angle.

9. The laser chamber according to claim 8,
wherein the first position coincides with a position corresponding to the first phase angle and the second position coincides with a position corresponding to the second phase angle.

10. The laser chamber according to claim 7,
wherein the first section is a section from the first phase angle to a third phase angle which is an angle between the first and second phase angles, and the first position coincides with a position corresponding to the first phase angle.

11. The laser chamber according to claim 7,
wherein the first section is a section from a third phase angle which is an angle between the first and second phase angles to the second phase angle, and the second position coincides with a position corresponding to the second phase angle.

12. The laser chamber according to claim 7,
wherein the first section is a continuous section.

13. The laser chamber according to claim 7,
wherein the first section includes a plurality of discontinuous sections whose sum of magnitudes of phase angles is 90° or more.

14. The laser chamber according to claim 13,
wherein the first section includes a section from the first phase angle to a third phase angle which is an angle between the first and second phase angles and a section from a fourth phase angle which is an angle between the third and second phase angles to the second phase angle, the first position coincides with a position corresponding to the first phase angle, and the second position coincides with a position corresponding to the second phase angle.

15. The laser chamber according to claim 1,
wherein the inner surface includes a planar portion in the vicinity of the cooling unit, and
when the laser chamber is viewed in cross section in a plane perpendicular to the second direction, an angle formed between a tangent line at the second position of the gas guide surface and the planar portion is less than 45°.

16. The laser chamber according to claim 1, further comprising a guide portion including a guide surface that faces the gas guide surface and defines the flow path,
wherein, when the laser chamber is viewed in cross-section in a plane perpendicular to the second direction, at least a part of the guide surface extends between third and fourth virtual curves over a third section corresponding to a phase angle of a magnitude of 90° or more of third and fourth virtual logarithmic spirals,
the third virtual curve having a curvature decreasing along the flow direction and being a virtual curve from a fifth phase angle to a sixth phase angle of the third virtual logarithmic spiral having an angle of 103° at which a straight line from a second origin and a tangent line of the third virtual curve intersect each other, and
the fourth virtual curve having a curvature decreasing along the flow direction and being a virtual curve from the fifth phase angle to the sixth phase angle of the fourth virtual logarithmic spiral having an angle of 96° at which a straight line from the second origin and a tangent line of the fourth virtual curve intersect each other.

17. The laser chamber according to claim 16,
wherein the first and second origins coincide with each other.

18. The laser chamber according to claim 16,
wherein the guide surface from one end portion of the guide portion in the first direction on the upstream side in the flow direction to the other end portion in the first direction on the downstream side extends over a fourth section including the third section, the fourth section corresponding to a section of the third and fourth virtual logarithmic spirals from the fifth phase angle to the sixth phase angle.

19. A discharge-excitation type gas laser device comprising:
an optical resonator; and
a laser chamber arranged on an optical path of the optical resonator;
the laser chamber including:
first and second discharge electrodes arranged in the laser chamber as facing each other in a direction parallel to a first direction, each of the first and second discharge electrodes extending in a second direction perpendicular to the first direction;
a fan arranged in the laser chamber, and configured to cause a laser gas in the laser chamber to circulate while rotating a flow direction of the laser gas about an axis parallel to the second direction; and
a cooling unit arranged in the laser chamber, and configured to cool the laser gas,
when the laser chamber is viewed in cross-section in a plane perpendicular to the second direction, at least a part of a gas guide surface out of an inner surface of the laser chamber extending between first and second virtual curves over a first section corresponding to a phase angle of a magnitude of 90° or more of first and second virtual logarithmic spirals,
the part of the gas guide surface being a part from a first position on an upstream side in the flow direction of the laser gas to a second position on a downstream side therein,
the inner surface defining a flow path of the laser gas through which the laser gas flows between the first and second discharge electrodes to a vicinity of the cooling unit,
the first virtual curve having a curvature decreasing along the flow direction and being a virtual curve from a first phase angle to a second phase angle of the first virtual logarithmic spiral having an angle of 103° at which a straight line from a first origin and a tangent line of the first virtual curve intersect each other, and
the second virtual curve having a curvature decreasing along the flow direction and being a virtual curve from the first phase angle to the second phase angle of the second virtual logarithmic spiral having an angle of 96° at which a straight line from the first origin and a tangent line of the second virtual curve intersect each other.

20. An electronic device manufacturing method, comprising:
generating laser light using a discharge-excitation-type gas laser device;
outputting the laser light to an exposure apparatus; and
exposing a photosensitive substrate to the laser light in the exposure apparatus to manufacture an electronic device,
the discharge-excitation-type gas laser device including:
an optical resonator; and
a laser chamber arranged on an optical path of the optical resonator;
the laser chamber including:
first and second discharge electrodes arranged in the laser chamber as facing each other in a direction parallel to a first direction, each of the first and second discharge electrodes extending in a second direction perpendicular to the first direction;
a fan arranged in the laser chamber, and configured to cause a laser gas in the laser chamber to circulate while rotating a flow direction of the laser gas about an axis parallel to the second direction; and
a cooling unit arranged in the laser chamber, and configured to cool the laser gas,
when the laser chamber is viewed in cross-section in a plane perpendicular to the second direction, at least a part of a gas guide surface out of an inner surface of the laser chamber extending between first and second virtual curves over a first section corresponding to a phase angle of a magnitude of 90° or more of first and second virtual logarithmic spirals,
the part of the gas guide surface being a part from a first position on an upstream side in the flow direction of the laser gas to a second position on a downstream side therein,
the inner surface defining a flow path of the laser gas through which the laser gas flows between the first and second discharge electrodes to a vicinity of the cooling unit,
the first virtual curve having a curvature decreasing along the flow direction and being a virtual curve from a first phase angle to a second phase angle of the first virtual logarithmic spiral having an angle of 103° at which a straight line from a first origin and a tangent line of the first virtual curve intersect each other, and
the second virtual curve having a curvature decreasing along the flow direction and being a virtual curve from the first phase angle to the second phase angle of the second virtual logarithmic spiral having an angle of 96° at which a straight line from the first origin and a tangent line of the second virtual curve intersect each other.
